(19) United States
(12) Patent Application Publication
(10) Pub. No.: US 2021/0319058 A1
(43) Pub. Date: Oct. 14, 2021

(54) LOCATION-BASED ALARM NOTIFICATION APPLICATION

(71) Applicant: Lindsay K Germain, Oakland, CA (US)

(72) Inventor: Lindsay K Germain, Oakland, CA (US)

(21) Appl. No.: 16/846,257

(22) Filed: Apr. 10, 2020

(51) Int. Cl. G06F 16/55; G06N 5/04; G06F 3/0484

(52) U.S. Cl. CPC G06F 16/55; G06F 3/04842; G06N 5/04

(57) ABSTRACT

A system providing a photo classification and selection application for receiving a set of images in a high-resolution format to identify which, if any, of the images possesses a set of composition and quality characteristics to match a desired brand, theme, or similar use. The images are assigned an initial classification type based upon automated processing of the set of images. The initial classifications for each image are validated once automatically determined, via a user interface or Lookbook. Validated images then may be automatically used to define a Lookbook of images for use by stakeholders with a high degree of confidence that the images included in the Lookbook possess the desired characteristics.

### CROSS-REFERENCE TO RELATED APPLICATIONS

### TECHNICAL FIELD

This application relates in general to a system and method for providing a photo classification and selection application, and more specifically, to a system and method for providing a photo classification and selection application using artificial intelligence processing.

### BACKGROUND

When creative directors, art directors, photographers, and agencies select photos today, the process is time consuming and feels overwhelming because there are typically hundreds, thousands, or tens of thousands of images reviewed by hand. Selection is a multi-stakeholder process, often involving 1-5 approval parties, and can sometimes require final client selection re-approval. This process can be improved in time and money efficiency, and time to completion, by using AI to understand and parse the selections to pre-recommend selections for the creative selector to review.

Cameras shoot in a time series, which means all photography is incidentally pre-organized by the tool creating the images. That means batches of the same shot are grouped together such that an index could easily create an exploitable starting point selection from the group of shots.

Photographers shoot imagery with many raw photos produced for each “shot.” In the field, this usage of “shot” refers to a chosen scene and scenario or angle of shooting photography. Photographers typically use a library of low-resolution photos to share with the selectors, or serve as a selector in some cases. These selected photos are circulated within the stakeholder group and often selectors develop individual groups of photos, called “selects”. These selects are then shared or negotiated by stakeholders in groups with several approvers/selectors. Selection is currently a manual process of reviewing hundreds or thousands of raw files/low-resolution images. This application would significantly improve the speed to deliver pre-selected images that can be confirmed by user curation.

Other mechanisms are needed that increase the efficiency of a workflow for receiving and selecting photos while reducing both the time and amount of effort needed by creatives, selectors, and other stakeholders. Automating a classification process that attempts to assign one or more classification values to each photograph is needed. Once these photos are assigned their initial classification values, the set of images may need to be reviewed for accuracy of the initial classification before a selected set of photographs may be generated for use by all stakeholders.

The present invention attempts to address the existing limitations in systems for providing a photo classification and selection application using artificial intelligence processing according to the principles and example embodiments disclosed herein.

### SUMMARY

In accordance with the present invention, the above and other problems are solved by providing systems and methods for providing a photo classification and selection application according to the principles and example embodiments disclosed herein.

In one embodiment, the present invention is a system for providing a photo classification and selection application. The invention provides a photo classification and selection application for receiving a set of images in a high-resolution format to identify which, if any, of the images possesses a set of composition and quality characteristics to match a desired brand, theme, or similar use. The images are assigned an initial classification type based upon automated processing of the set of images. The initial classifications for each image are validated once automatically determined. Validated images may be then automatically used to define a set (hereafter referred to as a “Lookbook”) of images for use by stakeholders with a high degree of confidence that the images included in the Lookbook possess the desired characteristics.

In another embodiment, the present invention is a method for providing a photo classification and selection application. The method receives a set of images in a high-resolution format, generates compressed low-resolution images corresponding to the received images, automatically generates a classification type for each image in the set of images, validates the classification type using user input, and generates a Lookbook for images having a particular classification type.

The great utility of the invention is that systems and methods provide a photo classification and selection application that automates a classification of photographs based upon their content, composition, and image quality to conform to a particular brand, identity, or theme.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention. The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way. Referring now to the drawings in which like reference numbers represent corresponding parts throughout:

FIG. 1 illustrates an example embodiment for a photo classification and selection application according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a user screen shot of a system providing a photo classification and selection application according to the present invention.

FIG. 4 illustrates another embodiment of a user screen shot of a system providing a photo classification and selection application according to the present invention.

FIG. 5 illustrates a computing system of software components providing a photo classification and selection application according to the present invention.

FIG. 6 illustrates a flowchart for method executed on a programmable device to provide photo classification and selection according to the present invention.

### DETAILED DESCRIPTION

This application relates in general to a system and method for providing a photo classification and selection application according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The term “user” and “photographer” refers to an entity, e.g. a human, that operates a digital camera and image processing computer system according to the present invention in order to bring about a desired effect or outcome. In a particular case, the user is one that uploads photographs from a camera and processes them to classify and select good, on-brand photos for submission to clients. For such a user, the terms “user” and “photographer” may be used herein interchangeably.

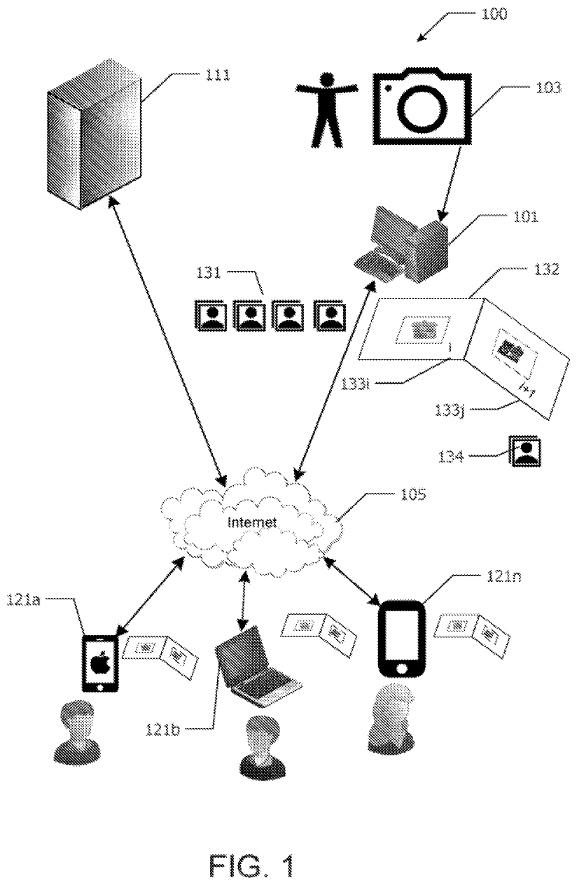

In general, the present disclosure relates a system and method for providing a photo classification and selection application. To better understand the present invention, FIG. 1 illustrates an example embodiment for a photo classification and selection application according to the present invention. This photo selection application 100 is shown as a distributed processing system in which various components and related functionality are performed on different processing systems. The application accepts a set of high resolution (“hi-res”) photographs 105 from camera 103 to a photography processing system 101. The application ultimately generates a “Lookbook” 132, a digital representation of a photo album containing the best photographs from the set of hi-res photos 131 according to a recognized standard of photographic content/composition and to a recognized standard of image quality. This application may also generate a set of final images 134 in one or more file formats and image resolution.

The recognized standard of photographic content are identifiable photographic characteristics that may be used to identify a set of photos with a similar brand, style, composition, object(s), subject(s), photographer viewpoint or focal point, content, or any other visual style standard. The recognized standard of photographic quality are identifiable characteristics such as improper exposures, lower photographic quality than other images in a batch or shot, and excess of saturated pixels, as well as identifying and eliminating photography from consideration where recognized person is/are blinking his or her eyes or where measurable sharpness of a photograph indicates that the images are too fuzzy for use.

The photography processing system 101 ingests a file of raw original images (hi-res files), compresses them and generates low-resolution file(s) corresponding to the original raw images via an index system for each original. This photography processing system 101 systematically selects a number of images and returns them in a “Lookbook” library of preferred selects. This Lookbook would function as a preview tool for all stakeholders, including clients, and function as a digital book, enabling collaboration, image swapping and confirmation. Tied to the index, these pre-selected images in the book enable exploration within areas of the file (using the index) that supports users to choose final selections from a particular series within the original photography batch.

The photography processing system 101 selects images 131 for inclusion in the Lookbook 132 based on trained criteria using Watson™ APIs or any AI photo recognition application 111. The commercially available AI tool 111, such as Watson™, is trained to recognize standards from a training set of images containing a prior hand-selected photo library of “selects” images. The training set of images may be used to identify a set of photos with a similar a brand or visual style standard that also surpasses a set of standard quality criteria.

The commercially available AI tool 111 receives a set of images 131 from the photographer processing system 101 to apply its identifiable photographic characteristics and recognized standard of photographic quality to the images to identify which subset of images best match “selects” characteristics and the remaining images are returned as non-select. These results are returned to the photography processing system 101.

The selections are validated through user approval and/or re-selection until a final set of images is confirmed for inclusion into a Lookbook 132. Using the index, the final set of raw images is exported to form a final high-resolution library of final selected images. The exported hi-res images are also formatted into a low-res Lookbook library 132 that may then be formatted into a plurality of formats that may then be sent to a plurality of stakeholder processing systems 121a-n for use as needed.

The photographer processing system 101 may store the change record for select and non-select status and comments made during the user approval process.

The photography processing system 101 will transmit the identity of all images in which the automatically-generated select images have had their status changed between select and non-select during the user approval process. The commercially available AI tool 111 uses the identity of these status-changed images and all system generated analysis measures that generated an incorrect result, to update its selection application for use in subsequent image processing. The commercially available AI tool 111 typically improves its predictive capacity to determine selects and non-selects by using these user validated results.

For the purposes of the example embodiment of FIG. 1, various functions are shown to be performed on different programmable computing devices that communicate with each other over the Internet. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the overall functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instruction for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

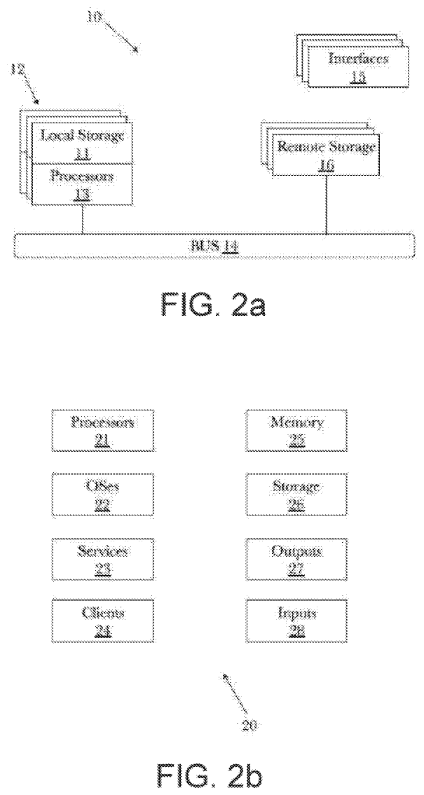

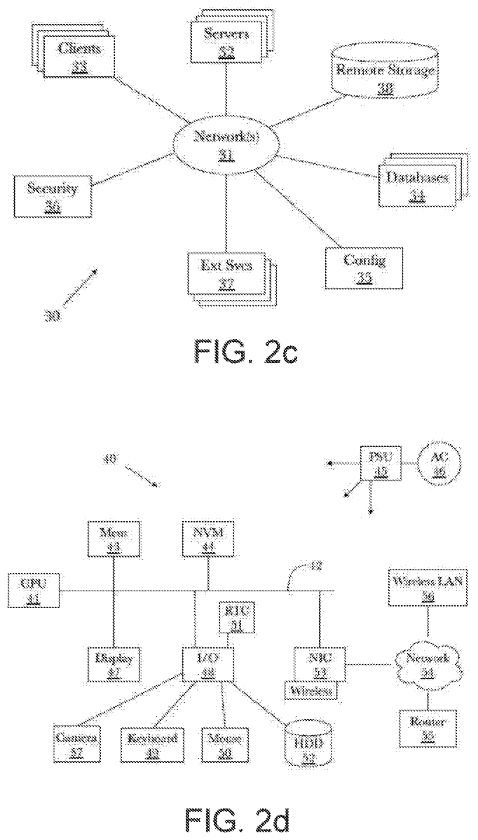

Referring now to FIG. 2a, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interfaces (HSSI), Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

In some aspects, systems may be implemented on a standalone computing system. Referring now to FIG. 2b, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 2a). Examples of storage devices 26 include flash memory, magnetic hard drive, CD-ROM, and/or the like.

In some aspects, systems may be implemented on a distributed computing network, such as one having any number of clients and/or servers. Referring now to FIG. 2c, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in Fig. B. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected to memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of a system 40 is a power supply unit 45 connected, in this example, to a main alternating current (AC) supply 46. Not shown are batteries that could be present, and many other devices and modifications that are well known, but are not applicable, to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

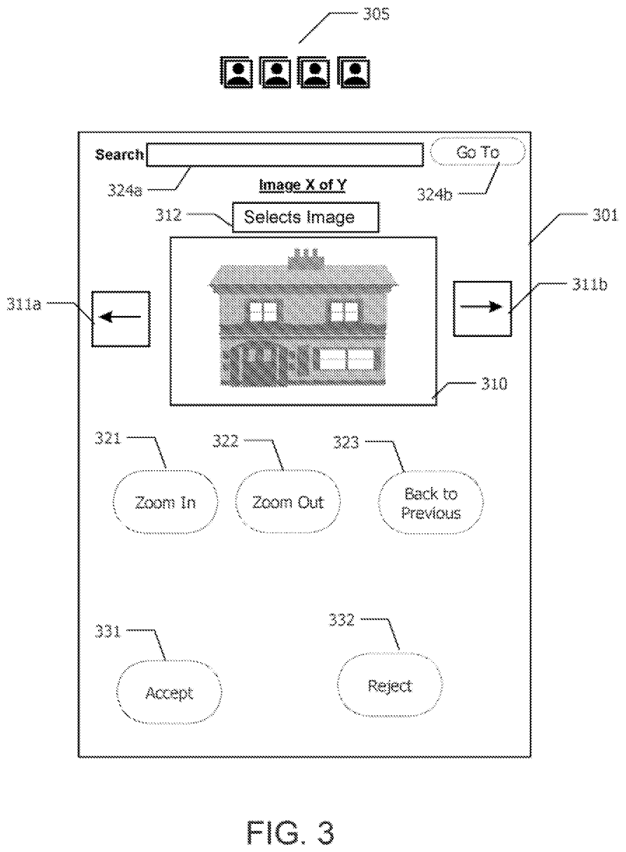

FIG. 3 illustrates an example embodiment of a user screen shot of a system providing a photo classification and selection application according to the present invention. The photography processing system 101 performs a validation process in which a set of photos that have been processed by an AI photo recognition application 111 is used to classify each image into either a selects-type photo or a non-selects-type photo. In this validation process, each image from the set of images being processed may be presented to a user for viewing along with an indication of its classification as either a selects-type photo or a non-selects-type photo, or the user may view the Lookbook 132 of selected images only. The user may review the images assigned to one or more specified classification type(s) and indicate whether the classification is correct or in error. The approved or updated classification type for each image is used to create a Lookbook 132 for stakeholders, including those responsible for reviewing/direction/approval and/or in need of the images.

A first user screen 301 is an example embodiment of an application screen in which a user may indicate whether the automatically generated classification type is correct. An image 310 is presented in a window on the first user screen 301 along with a classification type field 312 containing the automatically generated classification type corresponding to the image. Using an accept button 321, the user provides an indication that the automatically generated classification type is correct. The user provides an indication that the automatically generated classification type is incorrect using a reject button 322.

The user may navigate through the set of images being processed using the various navigation controls. A previous image control 311a and the next image control 31 lb may be used to step through a sequence of images in the set being processed one image at a time. The user may also navigate through the set of images using other controls such as Zoom in button 321, Zoom out button 322, and Back to Previous button 323. A search field 320a and a Go To button 324b work together to allow users to find individual photographs based upon filename and metadata searching. Back to Previous button 323 may permit the user to switch to a last viewed image, whether forward or backward, in the sequence of images and Go To button 324b allows the user to directly display a particular image in the set of images using the index value assigned to each image at the time the images are first processed. Other control buttons may also be used to select an image from the set of processed images in other mechanisms.

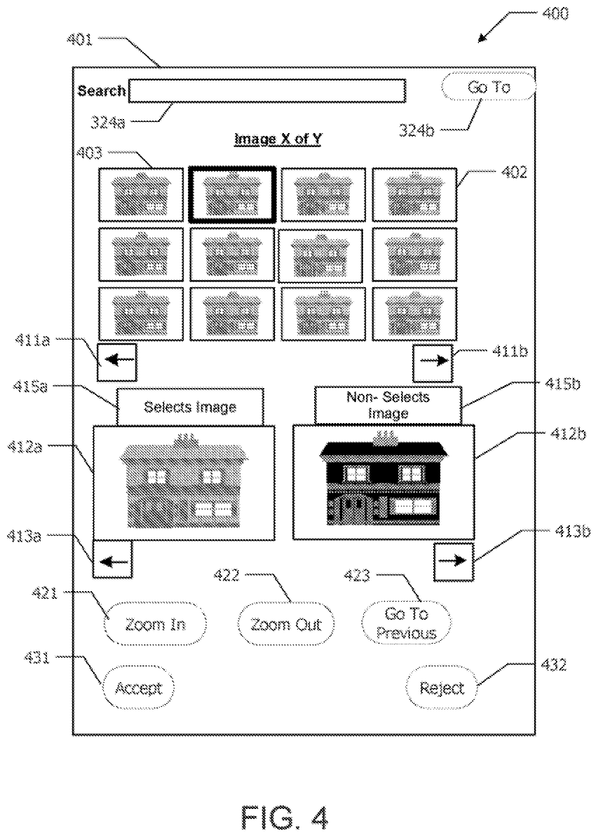

FIG. 4 illustrates another embodiment of a user screen shot of a system providing a photo classification and selection application according to the present invention. A second user screen 401 is another example embodiment of an application screen in which a user may indicate whether the automatically generated classification type is correct. An image 412a is presented in a window on the second user screen 401 along with a classification type field 415a containing the automatically generated classification type corresponding to the image. This image 412a corresponds to a selected image 403 from a plurality of thumbnail images 402. The selected image 403 may in indicated by a bolder line or other visual

A second image 412b that may be the second best recommendation is also presented in a window on the user screen 401 along with its corresponding classification type field 415b containing the automatically generated classification type corresponding to the image. The user may pick between the first image 412a and the second image 412b to be an active image for validation by clicking on the image that is to be considered active.

The user may provide an indication that the automatically generated classification type is correct for the active image using an Accept button 431 or an Accept All button 433. The user provides an indication that the automatically generated classification type is incorrect for the active image using a Reject button 432.

The second user screen 401 also presents a photo gallery of a subset of thumbnail images 402 that are within the set of processed images. The user may consider an image shown in the photo gallery 402 by clicking directly onto a desired thumbnail. This command causes the application to load a copy of the selected image into the currently active image window. As such, a user may consider two images at the same time when deciding whether a classification type should be accepted or rejected. A user may also wish to add a reference image that shows its subject matter with the composition and quality for a desired effect. If the composition of images that represent a particular brand is desired, a well-known reference image may be useful to compare a particular image from the set of processed images to assist in the validation decision.

The user may navigate through the set of images being processed using the various navigation controls. These navigation controls 421-424 operate in a similar manner as the user screen discussed above with respect to FIG. 3. The user may navigate through the gallery of images being processed using navigation controls 411a-411b that operate in a similar manner as the user screen discussed above with respect to FIG. 3. Other control buttons may also be used to select an image from the set of processed images in other mechanisms.

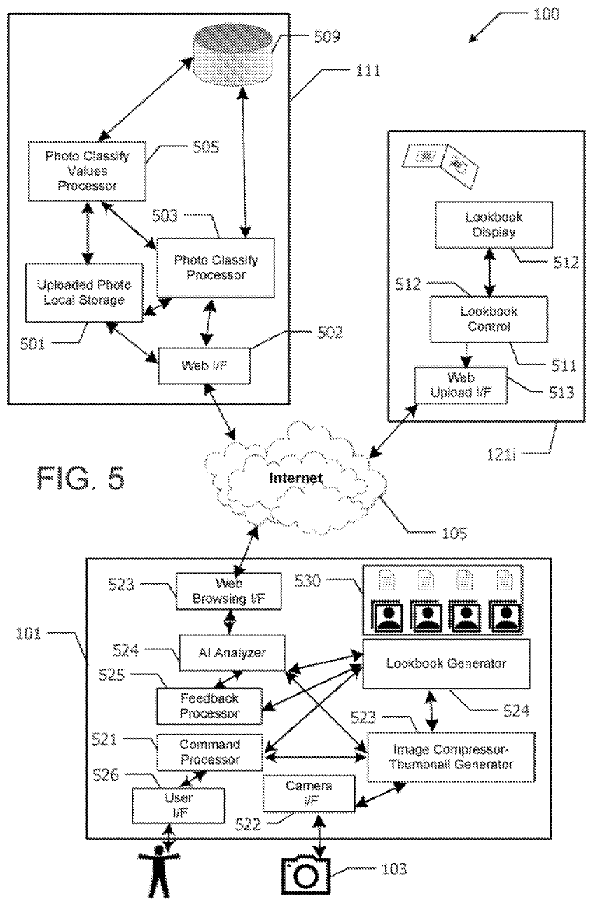

FIG. 5 illustrates a computing system of software components providing a photo classification and selection application according to the present invention. As discussed above, the system 100 may be constructed using a set of processing systems that use a distributed processing model. These processing systems include the photography processing system 101, the commercially available AI tool 111, and at least one of a plurality of stakeholder processing systems 121a-n. The photography processing system 101 receives a set of hi-res input images from a camera 103 via a camera interface 522 for receipt in an image compressor-thumbnail generator 523. This image compressor-thumbnail generator 523 receives the set of hi-res input images from a camera 103 and compresses the image into a smaller file format and generates a thumbnail image corresponding to the hi-res image. Each hi-res input image and lo-res image(s) corresponding to each other are assigned a unique index value before all of these image pairs are stored within local data storage 530. The unique index value may be used through the processing systems to obtain both the hi-res and corresponding lo-res images as needed. These hi-res images are typically not used and the large format hi-res files take long periods to move. Local data storage would really only need to store the smaller format (lower-res) and then the index can later be used to retrieve a high-res correlate (via index) for each final file. That parallels the manual process used now. The low-res version would likely be plural—multiple sizes generated at the beginning so that they're available for use on various displays.

A user interacts with the photography processing system 101 via a user interface 526 to submit commands to a command processor 521 which initiates any processing requested by the user on a set of images. The command processor 521 sends command messages to other processing elements to accomplish a desired processing task. The command processor 521 also sends messages to the user for display on a user display device (not shown) to inform the user of processing status, processing errors, and similar user data.

Once all of the hi-res and lo-res images are in local storage 530, the command processor 521 instructs the AI Analyzer 524 to send the entire set of lo-res images to the commercially available AI tool 111 via a web browsing interface 523. The commercially available AI tool 111 returns the entire set of images with each image now having initial classification type. This set of processed images are passed to a feedback processor 525. The feedback processor 525 interacts with a user via user interface 526 to obtain validation or correction of the initial classification type by presenting a digital Lookbook 132 of selects that enables re-selection. The user interacts with the feedback processor 525 until all of the images from the set that was returned by the commercially available AI tool 111 are validated or replaced with alternative selections manually with change records stored for each re-selection. The feedback processor 525 may also provide data to the commercially available AI tool 111 identifying which of the images in the processed set have required a change in the initial classification type set by the user.

The user indicates alternative selects until all of the images now have a correct classification that causes the feedback processor 525 to pass the corrected classification images to Lookbook generator 524. The Lookbook generator 524 uses the images having a selects classification to create a Lookbook. The processing up to this point has been performed on the compressed versions of the images and the Lookbook generator 524 uses the index value associated with each image to obtain the hi-res images corresponding to these selects images for inclusion in the final approved Lookbook 132. The Lookbook generator lays out pages for the Lookbook 132 with a defined page template that may be specified at the time the Lookbook is to be generated. The Lookbook 132 corresponds to a digital file that is viewable on programmable devices. The digital file may be created using a commonly used PDF file from Adobe Systems™ or any similar page definition file format. The completed Lookbook 132 may include the Lookbook set of raw hi-res images in a selected file formats and a composite Lookbook in various file formats and may be stored into local storage 530 and forwarded to a plurality of stakeholder processing systems 121i for use as needed.

The commercially available AI tool 111 corresponds to a third-party software product that contains functionality by its developer. For the purposes of understanding the present invention, the functionality of the commercially available AI tool 111 is described below to assist in clarifying the use of this tool. The commercially available AI tool 111 is constructed by a set of processing components coupled to an attached datastore 509.

A set of lo-res compressed images are uploaded from the photography processing system 101 via the Internet using a web interface 502. Typically, the set of images are sent as a series of individual files. Each image in the set of images may be represented by one or more data files. One file may contain digital data corresponding to pixels in each image. Additional files may be associated with each image to contain other information such as image processing steps performed on a raw image to create a particular image, product- or brand-related information used to classify the image, and any classification-type and user change record data. This additional data may also be stored within metadata associated with each image to convey the same information.

When a set of compressed images are received via the web interface 502, the image files may be stored into uploaded photo local storage 501. Photo classify processor 503 retrieves these images, and possibly the associated data, and processes the image against a set of known images or measured characteristics calculated from these known images. The Photo classify processor 503 generates an initial classification recommendation from the commercially available AI tool 111, trained using a preset quality standard and for which training may be enhanced by a set of known user-provided images.

Once the set of images all have an initial classification type assigned, the set of images is returned to the photography processing system 101 for further actions to complete a Lookbook 132. The photo classify processor 503 may also receive data indicating which images from a set of processed images were associated with an initial classification type that was changed during the validation step by a user. This data will include the image, or image index if the set of images still exists in the uploaded photo local storage, the initial classification type, and the updated classification type. Other parameters may also be included if useful.

The photo classify processor 503 works with the photo classify values processor 505 to use the images with changed classification types to update and adjust its classification processing and decision-making logic to attempt to improve future assignment of classification types to similar sets of images. The photo classify values processor 505 may utilize data defining a model for the classification of images to be used in subsequent processing that is stored within a photo data store 506.

An example stakeholder processing system 121i consisting of a Lookbook controller 511, Lookbook display 512, and a web-upload interface 513. The Lookbook controller 512 is a user application capable of reading a Lookbook 132 in the digital file format used for presentation to a stakeholder via the Lookbook display. The stakeholder interacts with the Lookbook controller 511 to view each page in the Lookbook 132, navigate to a desired page in the Lookbook 132, annotate and print any page of the Lookbook 132, and all similar operations needed for the stakeholder to use or modify the Lookbook 132.

The Lookbook controller 511 may be implemented as a commercially available file reader, such as Adobe Acrobat™ or similar programs if a PDF file format is used to create the Lookbook 132. The Lookbook controller 511 may also be a custom application developed to present the Lookbook pages in a preferred manner. For example, a stakeholder processing system 121i may be a smartphone or tablet that can receive files over the Internet 105. Because these types of devices have different screen sizes, screen orientation, and a user touch interface, a stakeholder may benefit from a custom application that is capable of displaying a page of the Lookbook in a manner that best illustrates the images. The present invention may use any of these type of applications, and should not be limited in any way except by the claim language recited herein.

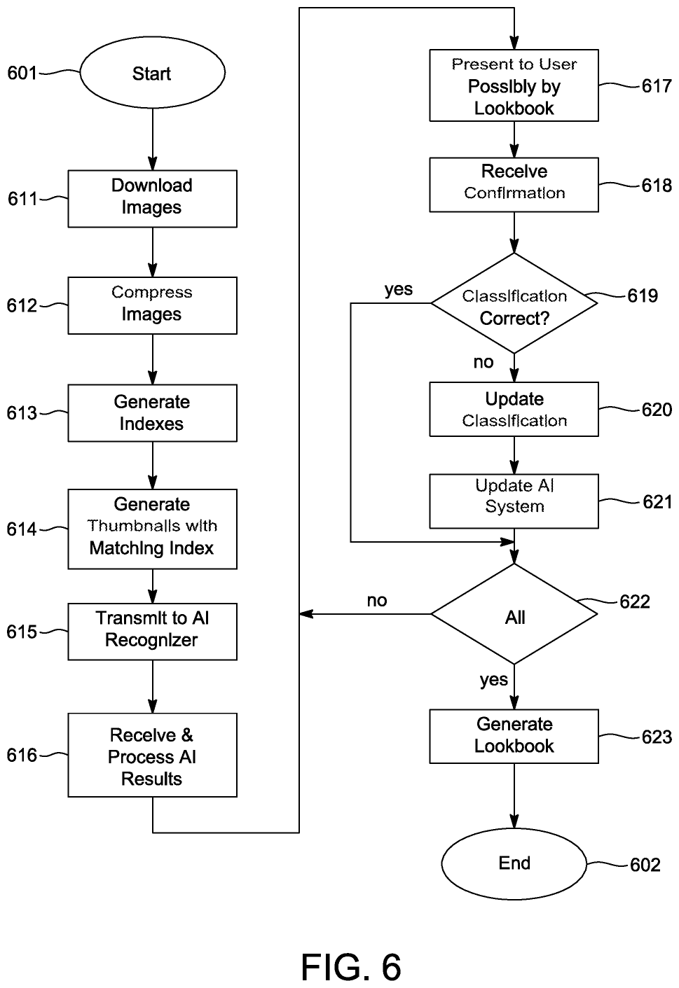

FIG. 6 illustrates a flowchart for the method executed on a programmable device to provide photo classification and selection according to the present invention. The processing begins 601 when a set of raw images are downloaded from a camera or memory card in step 611. Each image in the set of downloaded images is compressed in step 612 before step 613 generates an index for each image within the set of downloaded images.

A unique thumbnail with an index value corresponding to the index value of the hi-res original is generated and associated with each image in step 614, such that the index also corresponds to all of its different versions, i.e. raw hi-res image, compressed lo-res image(s), and thumbnail image. The index values are used to store the set of images within local data storage 530. The index value permits any processing component that possesses an image in one of the photo resolution versions to obtain a corresponding image in another form of the photo resolution versions when needed.

Once all of the images in the set are stored within the local data storage 530, the set of images are transmitted to the commercially available AI tool for initial classification in step 615. Step 616 subsequently receives the set of processed images having an AI recommendation that is used to assign an initial classification type.

The set of processed images having an initial classification type set are presented to a user in step 617 to permit a human to determine whether the classification type was determined accurately. Step 618 receives a confirmation input form the user that indicates if the initial classification is confirmed or whether it needs to be changed. Test step 619 determines if the classification type is correct and if so, passes the process to test step 622.

If test step 619 determines that the classification type is not correct based upon the user input, an updated classification type is associated with the image in step 620. The identity of the image, its initial classification type, and its updated classification type are saved in step 621 for transmission to the commercially available AI tool 111 to update its data. The processing now rejoins the processing from correctly classified images in test step 622.

Test step 622 determines if all of the images have been validated, and if not, returns to step 617 to begin processing of an additional image. Test step 622 may be based upon a user input that the validation process is complete, or be based upon all of the images having received a confirmation of rejection input from the user. This processing may wish to permit the user to review confirmations made before the validation process ends.

When test step 622 determines that all of the images have been validated, the set of images with a select classification are used to generate a final Lookbook 132 and various formats of final exported files from the final photography selects in the Lookbook by step 623 before the processing ends 602. As noted above, these processing steps may reference an image using its unique index value and retrieve a copy of the image in a particular resolution when required. The Lookbook 132 may retrieve hi-res images from the local data store 530 when creating the Lookbook.

The skilled person will be aware of a range of possible modifications of the various aspects described above. Accordingly, the present invention is defined by the claims and their equivalents. The applications of the present disclosure are not limited to the architecture of a particular computing system. Rather, computer systems described in FIGS. 2a-d are provided as examples of one type of computing device that may be adapted to perform the functions of a photography computing system 101, a commercially available AI tool 111, and/or the stakeholder computing system 121a-n, as shown in FIG. 1. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing a photo classification and selection application; the system comprises:
a command processor for interacting with a user;
an image compressor for generating images in additional lower resolutions based upon a set of high-resolution input images;
an AI analyzer, the AI Analyzer transmits a set of low-resolution images to an image classification tool and receives a recommendation used to generate an initial classification type; and
a feedback processor for interacting with the user to receive input for validating each classification type associated with each of the processed images.

2. The system according to claim 1, wherein the system further comprises a Lookbook generator for utilizing processed images having a classification type corresponding to a selects classification to create a visual presentation of the images.

3. The system according to claim 2, wherein the Lookbook generator creates a Lookbook file presenting processed images having a classification type corresponding to a selects classification using a predefined page template.

4. The system according to claim 3, wherein the Lookbook file is presented to a user on a display device.

5. The system according to claim 3, wherein the Lookbook file corresponds to a PDF data file.

6. The system according to claim 3, wherein the Lookbook file uses high resolution images obtained using an index value associated with the processed images that references corresponding high resolution images.

7. A method for providing a photo classification and selection application, the method comprising:
receiving a set of images in a high-resolution format;
generating one or more compressed low-resolution images corresponding to the received images;
automatically generating a classification type for each image in the set of images;
validating the classification type using user input possibly via a Lookbook user interface; and
generating a Lookbook and original high-resolution photographs in various formats with version history and change data for images having a particular classification type.

8. The method according to claim 7, wherein the Lookbook comprises a Lookbook file presenting processed images having a classification type corresponding to a selects classification using a predefined page template.

9. The method according to claim 8, wherein the Lookbook file is presented to a user on a display device.

10. The method according to claim 8, wherein the Lookbook file corresponds to a PDF data file.
